(19) United States
(12) Patent Application Publication
(10) Pub. No.: US 2024/0193212 A1
(43) Pub. Date: Jun. 13, 2024

(54) Systems and Methods for Facilitating Semantic Search of Audio Content

(71) Applicant: Spotify AB, Stockholm (SE)

(72) Inventors: Diego Fernando Lorenzo CASABUENA GONZALEZ, New York, NY (US); Ian LOZINSKI, New Hope, PA (US); Xingran ZHU, Stockholm (SE)

(21) Appl. No.: 18/063,023

(22) Filed: Dec. 7, 2022

(51) Int. Cl. G06F 16/9532; G06F 16/31; G06F 40/295; G06F 40/30

(52) U.S. Cl. CPC G06F 16/9532; G06F 16/316; G06F 40/295; G06F 40/30

(57) ABSTRACT

The various implementations described herein include methods and devices for facilitating semantic search. In one aspect, a method includes obtaining audio content and extracting vocabulary terms from the audio content. The method further includes generating, using a transformer model, a vocabulary embedding from the vocabulary terms, and generating one or more topic embeddings from the audio content and the vocabulary embeddings. The method also includes generating a topic embedding index for the audio content based on the one or more topic embeddings, and storing the embedding index for use with a search engine system.

### TECHNICAL FIELD

The disclosed embodiments relate generally to semantic search including, but not limited to, systems and methods for generating vocabulary embeddings, topic embeddings, and topic indices.

### BACKGROUND

Recent years have shown a remarkable growth in consumption of digital goods such as digital music, movies, books, and podcasts, among many others. The overwhelmingly large number of these goods often makes navigation and discovery of new digital goods an extremely difficult task. Recommender systems commonly retrieve preferred items for users from a massive number of items by modeling users' interests based on historical interactions. However, reliance on lexical search and/or historical interaction data is limiting for user exploration and item discovery. This problem is further aggravated for long media items and media items with limited metadata and/or labels.

### SUMMARY

Semantic search is a data searching technique in a which a search system not only matches keywords, but attempts to match intent and contextual meanings. Semantic search allows users to use natural language, ask questions, and input queries using general terms. In this way, semantic search is able to return more granular results and/or expose more content (e.g., long tail content).

Attempting to index podcasts and other long media items directly results in representations (e.g., embeddings) of strings of arbitrary length. Many search systems cannot handle such arbitrary-length strings. The present disclosure describes identifying topics from media items and generating topic representations (e.g., the representation of each topic having a preset number of bits). For example, the main topics are extracted from the media items (e.g., the top 5, 10, or 20 topics) and the main topics are converted to topic embeddings. As described herein, a semantic system having one or more topic indices can generate a semantic representation (e.g., embedding) of a query and match that semantic representation to one or more topics of the topic indices. The topics may include one or more words and/or expressions.

In accordance with some embodiments, a method generating a topic index is provided. The method includes: (i) obtaining audio content; (ii) extracting vocabulary terms from the audio content; (iii) generating, using a transformer model, a vocabulary embedding from the vocabulary terms; (iv) generating one or more topic embeddings from the audio content and the vocabulary embeddings; (v) generating a topic embedding index for the audio content based on the one or more topic embeddings; and (vi) storing the embedding index for use with a search engine system.

In accordance with some embodiments, an electronic device is provided. The electronic device includes one or more processors and memory storing one or more programs. The one or more programs include instructions for performing any of the methods described herein (e.g., the method 700).

In accordance with some embodiments, a non-transitory computer-readable storage medium is provided. The non-transitory computer-readable storage medium stores one or more programs for execution by an electronic device with one or more processors. The one or more programs comprising instructions for performing any of the methods described herein (e.g., the method 700).

Thus, devices and systems are disclosed with methods for generating topic indices for performing semantic searches. Such methods, devices, and systems may complement or replace conventional methods, devices, and systems for generating topic indices and/or performing semantic searches.

### BRIEF DESCRIPTION OF THE DRAWINGS

The embodiments disclosed herein are illustrated by way of example, and not by way of limitation, in the figures of the accompanying drawings. Like reference numerals refer to corresponding parts throughout the drawings and specification.

FIG. 1 is a block diagram illustrating an example media content delivery system in accordance with some embodiments.

FIG. 2 is a block diagram illustrating an example electronic device in accordance with some embodiments.

FIG. 3 is a block diagram illustrating an example media content server in accordance with some embodiments.

FIGS. 4A-4D illustrate example semantic modeling and topic embedding spaces in accordance with some embodiments.

FIG. 5 is a flow diagram illustrating an example vocabulary generation procedure in accordance with some embodiments.

FIGS. 6A-6B are a flow diagram illustrating an example indexing procedure in accordance with some embodiments.

FIG. 6C is a flow diagram illustrating an example searching procedure in accordance with some embodiments.

FIGS. 7A-7C are flow diagrams illustrating a method of recommending content to a user in accordance with some embodiments.

### DETAILED DESCRIPTION

There is a lack of semantic search tools for podcasts and other audio content, particularly long form audio content that lasts minutes or hours. A significant obstacle to semantic search is that embedding podcasts and other types of content as these can be quite long. Approaches such as averaging sentence embeddings and computing paragraph-level summarizations are insufficient to ensure that embedding length is fixed (as required by many models) and the search results remain accurate.

A solution described herein is to generate topic embeddings, where the top N topics for any length of audio content can be determined and used for a semantic search. The disclosed procedures include generating topic embeddings for media item (e.g., podcasts and/or podcast segments) and generating a topic embedding for a query. Nearest neighbors can be identified (e.g., using a K-nearest neighbors (KNN) algorithm) for the query embedding and returned as results to the user. Such an approach does not depend on identifying speakers (or the number of speakers) and may work for any language.

Reference will now be made to embodiments, examples of which are illustrated in the accompanying drawings. In the following description, numerous specific details are set forth in order to provide an understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

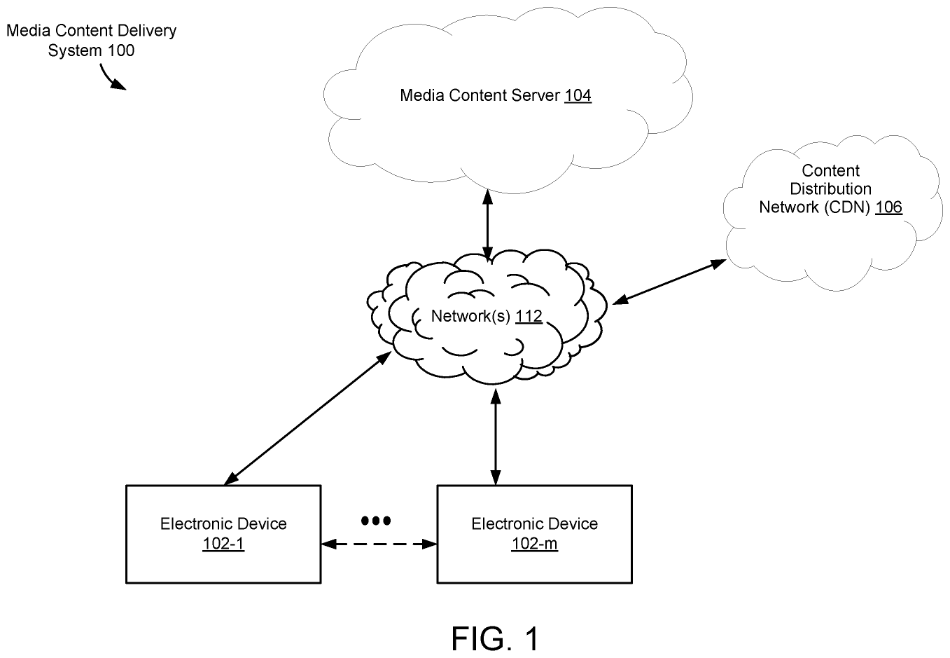

FIG. 1 is a block diagram illustrating a media content delivery system 100 in accordance with some embodiments. The media content delivery system 100 includes one or more electronic devices 102 (e.g., electronic device 102-1 to electronic device 102-m, where m is an integer greater than one), one or more media content servers 104, and/or one or more content distribution networks (CDNs) 106. The one or more media content servers 104 are associated with (e.g., at least partially compose) a media-providing service. The one or more CDNs 106 store and/or provide one or more content items (e.g., to electronic devices 102). In some embodiments, the CDNs 106 are included in the media content servers 104. One or more networks 112 communicably couple the components of the media content delivery system 100. In some embodiments, the one or more networks 112 include public communication networks, private communication networks, or a combination of both public and private communication networks. For example, the one or more networks 112 can be any network (or combination of networks) such as the Internet, other wide area networks (WAN), local area networks (LAN), virtual private networks (VPN), metropolitan area networks (MAN), peer-to-peer networks, and/or ad-hoc connections.

In some embodiments, an electronic device 102 is associated with one or more users. In some embodiments, an electronic device 102 is a personal computer, mobile electronic device, wearable computing device, laptop computer, tablet computer, mobile phone, feature phone, smart phone, an infotainment system, digital media player, a speaker, television (TV), and/or any other electronic device capable of presenting media content (e.g., controlling playback of media items, such as music tracks, podcasts, videos, etc.). Electronic devices 102 may connect to each other wirelessly and/or through a wired connection (e.g., directly through an interface, such as an HDMI interface). In some embodiments, electronic devices 102-1 and 102-m are the same type of device (e.g., electronic device 102-1 and electronic device 102-m are both speakers). Alternatively, electronic device 102-1 and electronic device 102-m include two or more different types of devices.

In some embodiments, electronic devices 102-1 and 102-m send and receive media-control information through network(s) 112. For example, electronic devices 102-1 and 102-m send media control requests (e.g., requests to play music, podcasts, movies, videos, or other media items, or playlists thereof) to media content server 104 through network(s) 112. Additionally, electronic devices 102-1 and 102-m, in some embodiments, also send indications of media content items to media content server 104 through network(s) 112. In some embodiments, the media content items are uploaded to electronic devices 102-1 and 102-m before the electronic devices forward the media content items to media content server 104.

In some embodiments, electronic device 102-1 communicates directly with electronic device 102-m (e.g., as illustrated by the dotted-line arrow), or any other electronic device 102. As illustrated in FIG. 1, electronic device 102-1 is able to communicate directly (e.g., through a wired connection and/or through a short-range wireless signal, such as those associated with personal-area-network (e.g., BLUETOOTH/BLE) communication technologies, radio-frequency-based near-field communication technologies, infrared communication technologies, etc.) with electronic device 102-m. In some embodiments, electronic device 102-1 communicates with electronic device 102-m through network(s) 112. In some embodiments, electronic device 102-1 uses the direct connection with electronic device 102-m to stream content (e.g., data for media items) for playback on the electronic device 102-m.

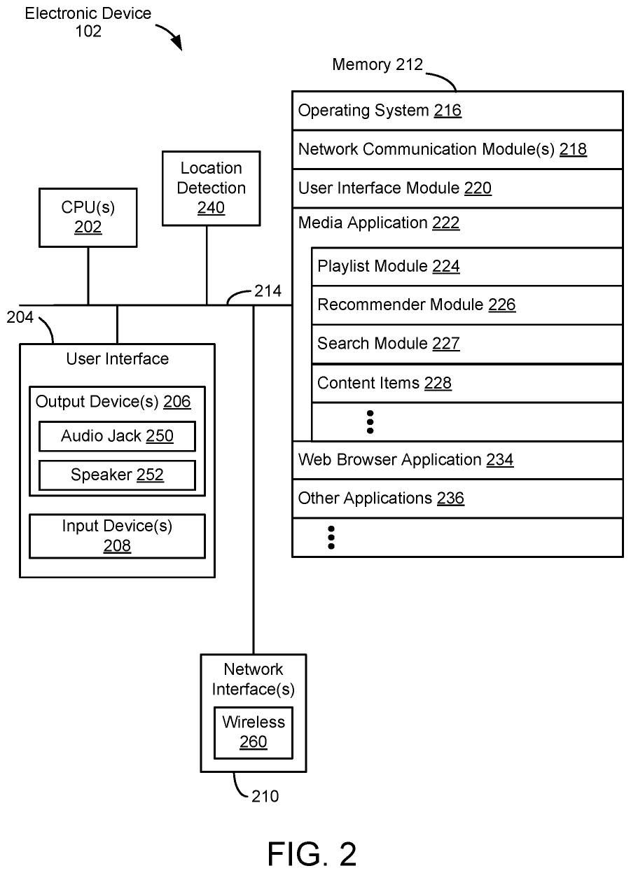

In some embodiments, electronic device 102-1 and/or electronic device 102-m include a media application 222 (FIG. 2) that allows a respective user of the respective electronic device to upload (e.g., to media content server 104), browse, request (e.g., for playback at the electronic device 102), and/or present media content (e.g., control playback of music tracks, playlists, videos, etc.). In some embodiments, one or more media content items are stored locally by an electronic device 102 (e.g., in memory 212 of the electronic device 102, FIG. 2). In some embodiments, one or more media content items are received by an electronic device 102 in a data stream (e.g., from the CDN 106 and/or from the media content server 104). The electronic device(s) 102 are capable of receiving media content (e.g., from the CDN 106) and presenting the received media content. For example, electronic device 102-1 may be a component of a network-connected audio/video system (e.g., a home entertainment system, a radio/alarm clock with a digital display, or an infotainment system of a vehicle). In some embodiments, the CDN 106 sends media content to the electronic device(s) 102.

In some embodiments, the CDN 106 stores and provides media content (e.g., media content requested by the media application 222 of electronic device 102) to electronic device 102 via the network(s) 112. Content (also referred to herein as “media items,” “media content items,” and “content items”) is received, stored, and/or served by the CDN 106. In some embodiments, content includes audio (e.g., music, spoken word, podcasts, audiobooks, etc.), video (e.g., short-form videos, music videos, television shows, movies, clips, previews, etc.), text (e.g., articles, blog posts, emails, etc.), image data (e.g., image files, photographs, drawings, renderings, etc.), games (e.g., 2- or 3-dimensional graphics-based computer games, etc.), or any combination of content types (e.g., web pages that include any combination of the foregoing types of content or other content not explicitly listed). In some embodiments, content includes one or more audio media items (also referred to herein as “audio items,” “tracks,” and/or “audio tracks”).

In some embodiments, media content server 104 receives media requests (e.g., commands) from electronic devices 102. In some embodiments, media content server 104 includes a voice API, a connect API, and/or key service. In some embodiments, media content server 104 validates (e.g., using key service) electronic devices 102 by exchanging one or more keys (e.g., tokens) with electronic device(s) 102.

In some embodiments, media content server 104 and/or CDN 106 stores one or more playlists (e.g., information indicating a set of media content items). For example, a playlist is a set of media content items defined by a user and/or defined by an editor associated with a media-providing service. The description of the media content server 104 as a “server” is intended as a functional description of the devices, systems, processor cores, and/or other components that provide the functionality attributed to the media content server 104. It will be understood that the media content server 104 may be a single server computer, or may be multiple server computers. Moreover, the media content server 104 may be coupled to CDN 106 and/or other servers and/or server systems, or other devices, such as other client devices, databases, content delivery networks (e.g., peer-to-peer networks), network caches, and the like. In some embodiments, the media content server 104 is implemented by multiple computing devices working together to perform the actions of a server system (e.g., cloud computing).

FIG. 2 is a block diagram illustrating an electronic device 102 (e.g., electronic device 102-1 and/or electronic device 102-m, FIG. 1), in accordance with some embodiments. The electronic device 102 includes one or more central processing units (CPU(s), e.g., processors or cores) 202, one or more network (or other communications) interfaces 210, memory 212, and one or more communication buses 214 for interconnecting these components. The communication buses 214 optionally include circuitry (sometimes called a chipset) that interconnects and controls communications between system components.

In some embodiments, the electronic device 102 includes a user interface 204, including output device(s) 206 and/or input device(s) 208. In some embodiments, the input devices 208 include a keyboard, mouse, or track pad. Alternatively, or in addition, in some embodiments, the user interface 204 includes a display device that includes a touch-sensitive surface, in which case the display device is a touch-sensitive display. In electronic devices that have a touch-sensitive display, a physical keyboard is optional (e.g., a soft keyboard may be displayed when keyboard entry is needed). In some embodiments, the output devices (e.g., output device(s) 206) include a speaker 252 (e.g., speakerphone device) and/or an audio jack 250 (or other physical output connection port) for connecting to speakers, earphones, headphones, or other external listening devices. Furthermore, some electronic devices 102 use a microphone and voice recognition device to supplement or replace the keyboard. Optionally, the electronic device 102 includes an audio input device (e.g., a microphone) to capture audio (e.g., speech from a user).

Optionally, the electronic device 102 includes a location-detection device 240, such as a global navigation satellite system (GNSS) (e.g., GPS (global positioning system), GLONASS, Galileo, BeiDou) or other geo-location receiver, and/or location-detection software for determining the location of the electronic device 102 (e.g., module for finding a position of the electronic device 102 using trilateration of measured signal strengths for nearby devices).

In some embodiments, the one or more network interfaces 210 include wireless and/or wired interfaces for receiving data from and/or transmitting data to other electronic devices 102, a media content server 104, a CDN 106, and/or other devices or systems. In some embodiments, data communications are carried out using any of a variety of custom or standard wireless protocols (e.g., NFC, RFID, IEEE 802.15.4, Wi-Fi, ZigBee, 6LoWPAN, Thread, Z-Wave, Bluetooth, ISA100.11a, WirelessHART, MiWi, etc.). Furthermore, in some embodiments, data communications are carried out using any of a variety of custom or standard wired protocols (e.g., USB, Firewire, Ethernet, etc.). For example, the one or more network interfaces 210 include a wireless interface 260 for enabling wireless data communications with other electronic devices 102, media presentations systems, and/or or other wireless (e.g., Bluetooth-compatible) devices (e.g., for streaming audio data to the media presentations system of an automobile). Furthermore, in some embodiments, the wireless interface 260 (or a different communications interface of the one or more network interfaces 210) enables data communications with other WLAN-compatible devices (e.g., a media presentations system) and/or the media content server 104 (via the one or more network(s) 112, FIG. 1).

In some embodiments, electronic device 102 includes one or more sensors including, but not limited to, accelerometers, gyroscopes, compasses, magnetometer, light sensors, near field communication transceivers, barometers, humidity sensors, temperature sensors, proximity sensors, range finders, and/or other sensors/devices for sensing and measuring various environmental conditions.

Memory 212 includes high-speed random-access memory, such as DRAM, SRAM, DDR RAM, or other random-access solid-state memory devices; and may include non-volatile memory, such as one or more magnetic disk storage devices, optical disk storage devices, flash memory devices, or other non-volatile solid-state storage devices. Memory 212 may optionally include one or more storage devices remotely located from the CPU(s) 202. Memory 212, or alternately, the non-volatile memory solid-state storage devices within memory 212, includes a non-transitory computer-readable storage medium. In some embodiments, memory 212 or the non-transitory computer-readable storage medium of memory 212 stores the following programs, modules, and data structures, or a subset or superset thereof:
an operating system 216 that includes procedures for handling various basic system services and for performing hardware-dependent tasks;
network communication module(s) 218 for connecting the electronic device 102 to other computing devices (e.g., media presentation system(s), media content server 104, and/or other client devices) via the one or more network interface(s) 210 (wired or wireless) connected to one or more network(s) 112;
a user interface module 220 that receives commands and/or inputs from a user via the user interface 204 (e.g., from the input devices 208) and provides outputs for playback and/or display on the user interface 204 (e.g., the output devices 206);
a media application 222 (e.g., an application for accessing a media-providing service of a media content provider associated with media content server 104) for uploading, browsing, receiving, processing, presenting, and/or requesting playback of media (e.g., media items). In some embodiments, media application 222 includes a media player, a streaming media application, and/or any other appropriate application or component of an application. In some embodiments, media application 222 is used to monitor, store, and/or transmit (e.g., to media content server 104) data associated with user behavior. In some embodiments, media application 222 also includes the following modules (or sets of instructions), or a subset or superset thereof:
   a playlist module 224 for storing sets of media items for playback in a predefined order;
   a recommender module 226 for identifying and/or displaying recommended media items to include in a playlist;
   a search module 227 for identifying and presenting media items to a user in response to one or more queries; and
   a content items module 228 for storing media items, including audio items such as podcasts and songs, for playback and/or for forwarding requests for media content items to the media content server;
a web browser application 234 for accessing, viewing, and interacting with web sites; and
other applications 236, such as applications for word processing, calendaring, mapping, weather, stocks, time keeping, virtual digital assistant, presenting, number crunching (spreadsheets), drawing, instant messaging, e-mail, telephony, video conferencing, photo management, video management, a digital music player, a digital video player, 2D gaming, 3D (e.g., virtual reality) gaming, electronic book reader, and/or workout support.

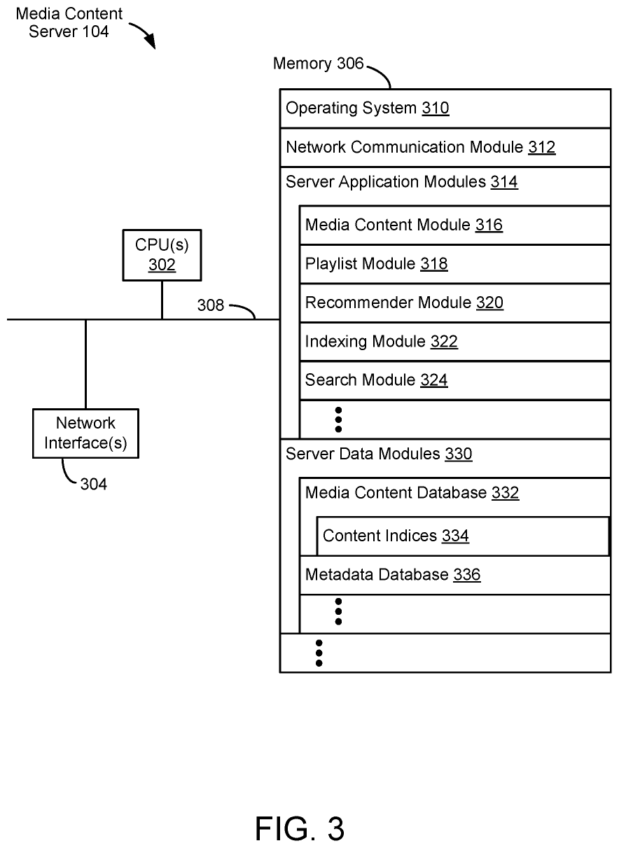

FIG. 3 is a block diagram illustrating a media content server 104, in accordance with some embodiments. The media content server 104 typically includes one or more central processing units/cores (CPUs) 302, one or more network interfaces 304, memory 306, and one or more communication buses 308 for interconnecting these components.

Memory 306 includes high-speed random-access memory, such as DRAM, SRAM, DDR RAM, or other random access solid-state memory devices; and may include non-volatile memory, such as one or more magnetic disk storage devices, optical disk storage devices, flash memory devices, or other non-volatile solid-state storage devices. Memory 306 optionally includes one or more storage devices remotely located from one or more CPUs 302. Memory 306, or, alternatively, the non-volatile solid-state memory device(s) within memory 306, includes a non-transitory computer-readable storage medium. In some embodiments, memory 306, or the non-transitory computer-readable storage medium of memory 306, stores the following programs, modules and data structures, or a subset or superset thereof:
an operating system 310 that includes procedures for handling various basic system services and for performing hardware-dependent tasks;
a network communication module 312 that is used for connecting the media content server 104 to other computing devices via one or more network interfaces 304 (wired or wireless) connected to one or more networks 112;
one or more server application modules 314 for performing various functions with respect to providing and managing a content service, the server application modules 314 including, but not limited to, one or more of:
   a media content module 316 for storing one or more media content items and/or sending (e.g., streaming), to the electronic device, one or more requested media content item(s);
   a playlist module 318 for storing and/or providing (e.g., streaming) sets of media content items to the electronic device;
   a recommender module 320 for determining and/or providing recommendations for a playlist;
   an indexing module 322 for identifying topics within media items and generating topic indices for the media items; and
   a search module 324 for searching one or more databases (e.g., the media content database 332 and/or the content indices 334) in response to user and/or system queries; and
one or more server data module(s) 330 for handling the storage of and/or access to media items and/or metadata relating to the media items; in some embodiments, the one or more server data module(s) 330 include:
   a media content database 332 for storing media items. In some embodiments, the media content database 332 includes one or more content indices 334 (e.g., generated via the indexing module 322); and
   a metadata database 336 for storing metadata relating to the media items, such as a genre associated with the respective media items.

In some embodiments, the media content server 104 includes web or Hypertext Transfer Protocol (HTTP) servers, File Transfer Protocol (FTP) servers, as well as web pages and applications implemented using Common Gateway Interface (CGI) script, PHP Hyper-text Preprocessor (PHP), Active Server Pages (ASP), Hyper Text Markup Language (HTML), Extensible Markup Language (XML), Java, JavaScript, Asynchronous JavaScript and XML (AJAX), XHP, Javelin, Wireless Universal Resource File (WURFL), and the like.

Each of the above identified modules stored in memory 212 and 306 corresponds to a set of instructions for performing a function described herein. The above identified modules or programs (e.g., sets of instructions) need not be implemented as separate software programs, procedures, or modules, and thus various subsets of these modules may be combined or otherwise re-arranged in various embodiments. In some embodiments, memory 212 and 306 optionally store a subset or superset of the respective modules and data structures identified above. Furthermore, memory 212 and 306 optionally store additional modules and data structures not described above.

Although FIG. 3 illustrates the media content server 104 in accordance with some embodiments, FIG. 3 is intended more as a functional description of the various features that may be present in one or more media content servers than as a structural schematic of the embodiments described herein. In practice, and as recognized by those of ordinary skill in the art, items shown separately could be combined and some items could be separated. For example, some items shown separately in FIG. 3 could be implemented on single servers and single items could be implemented by one or more servers. In some embodiments, media content database 332 and/or metadata database 336 are stored on devices (e.g., CDN 106) that are accessed by media content server 104. The actual number of servers used to implement the media content server 104, and how features are allocated among them, will vary from one implementation to another and, optionally, depends in part on the amount of data traffic that the server system handles during peak usage periods as well as during average usage periods.

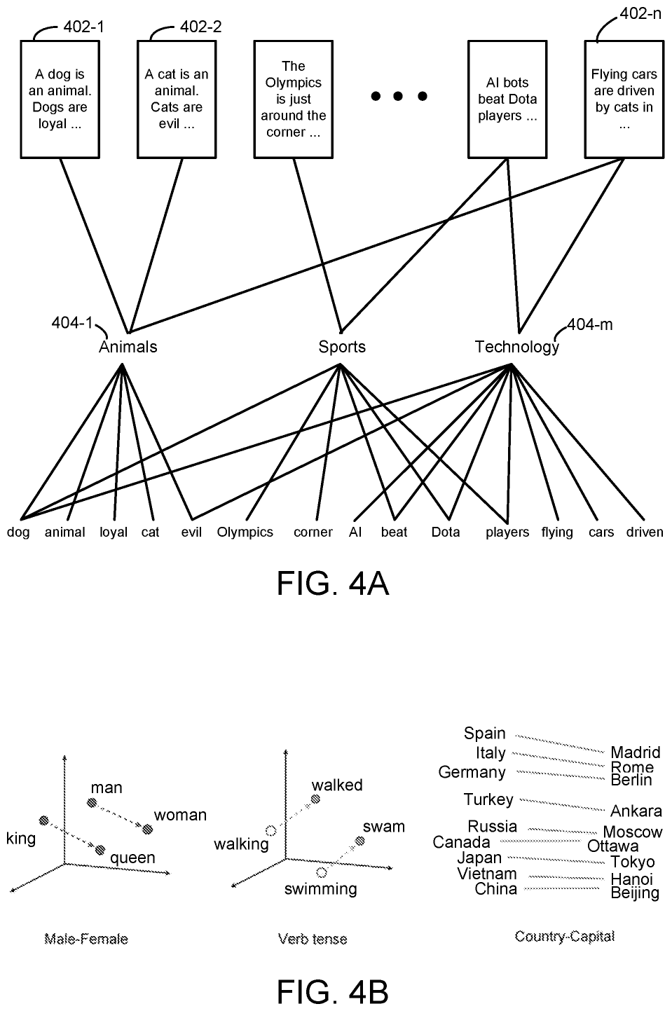

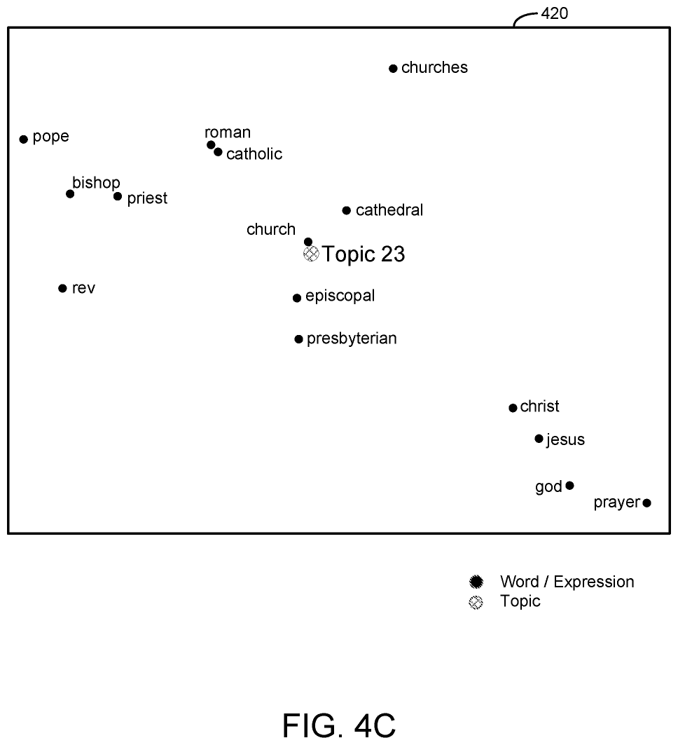

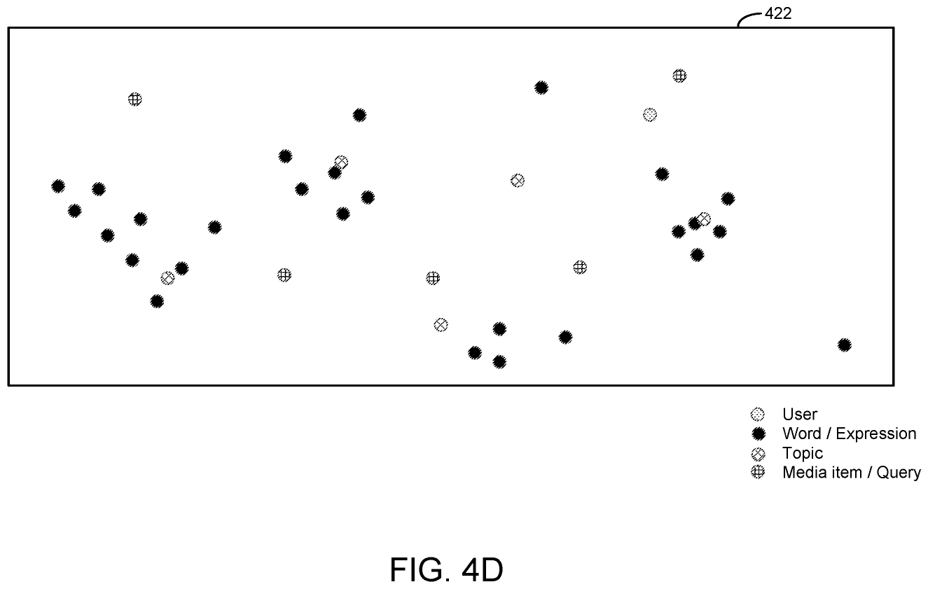

FIGS. 4A-4D illustrate example semantic modeling and topic embedding spaces in accordance with some embodiments. FIG. 4A shows a mapping of topics for a corpus of documents in accordance with some embodiments. As shown in FIG. 4A, each document 402 (e.g., an audio transcript) is mapped to a corresponding topic based on a representation of text from the document (e.g., a learned representation) matching a representation associated with the topic. The representation of the document text and the representation of the topic share underlying text key words, which can be computed and illustrated as in FIG. 4A. Membership in a given topic for one or more document texts implies the existence of a common set of text terms with the topic. In the example of FIG. 4A the document 402-1 describes dogs and the document 402-2 describes cats and each is linked to the animals topic 404-1. Also, in FIG. 4A, the document 402-n describes flying cars and is linked to the technology topic 404-m.

In some embodiments, the document text representations, the topic representations, and the mapping between them shown in FIG. 4A are generated using a probabilistic model, such as a latent Dirichlet allocation (LDA) model. In some embodiments, the document text representations, the topic representations, and the mapping between them are generated using a Bayesian model, in which each item of a collection is modeled as a finite mixture over an underlying set of topics. In some embodiments, a first model is used to calculate a topic distribution within an input document and a second model is used to generate embedding(s) for the topic distribution.

FIG. 4B shows semantic linking between terms and words in accordance with some embodiments. As shown in FIG. 4B, male and female terms are linked (e.g., the term king is linked to the term queen). Additionally, different verb tenses are linked (e.g., the term walking is linked to the term walked). As another example, countries and their capitals are linked (e.g., the city Madrid is linked to the country Spain). In some embodiments, the semantic links (e.g., associations) are used to train a model (e.g., a deep learning model such as Word2vec). In some embodiments, the model is trained to generate embeddings for a vocabulary of words, where embeddings capture co-occurrence of words. In some embodiments, the model is trained to generate embeddings for a vocabulary of phrases, sentences, and/or paragraphs, where embeddings capture co-occurrence of words and grammar, such as conjugation and sentence-level semantic context.

FIG. 4C shows a topic space 420 in accordance with some embodiments. The topic space 420 includes words/expressions and one or more topics (e.g., the Topic 23). In the example of FIG. 4C, the Topic 23 is associated with the words church, cathedral, and episcopal. In some embodiments, the topic space 420 is used to train a model, such as a generative model. In some embodiments, the model is trained to generate topic and document embeddings using combinations of topics, words, and semantic associations. In some embodiments, the model is an embedded topic model (ETM), that combines topic embeddings and word embeddings. In some embodiments, the model is trained to discover interpretable topics (e.g., regardless of vocabulary size and the inclusion of obscure words and/or stop words).

FIG. 4D shows a topic space 422 in accordance with some embodiments. The topic space 422 (e.g., a common embedding space) includes embeddings for users, words/expressions, topics, media items, and queries. In some embodiments, the various input entities embedded to the space in FIG. 4D represent a content hierarchy. For example, some elements can be words, others can be expressions using those words, and others can be queries and media items using those expressions. The derivation of topics and their respective embeddings can be seen/used as an instrument to generate a common mapping for these various entities, whose lengths/durations are diverse, and whose relationship can be compositional and/or hierarchical. In some embodiments, an embedding for a user is generated based on one or more user preferences and/or media consumption. In some embodiments, a transcript for a media item is input into the model to obtain proportions over topics in the topic space. In some embodiments, an embedding for a media item includes a weighted average of topics for the media item (e.g., weighted based on the topic proportions within the media item). In some embodiments, each topic is represented as a cluster in the topic space. In some embodiments, each media item is represented as a combination of clusters in the topic space. The identification of topics for a media item allows for distinguishing topics in different parts of the media item (e.g., distinguishing different segments such as different chapters and/or clips). In some embodiments, the topic space 422 includes a number of topics in the range of 500 topics to 30,000 topics. In some embodiments, the topic space 422 includes more than 30,000 topics.

Constructing a common topic embedding space with words, sentences, and longer entities (e.g., different input scales) mapped accurately across the different scales, as described herein, provides an advantage over conventional systems that are only able to provide topic embeddings for a single scale (e.g., individual words) as arbitrary length inputs can be mapped to the topic space.

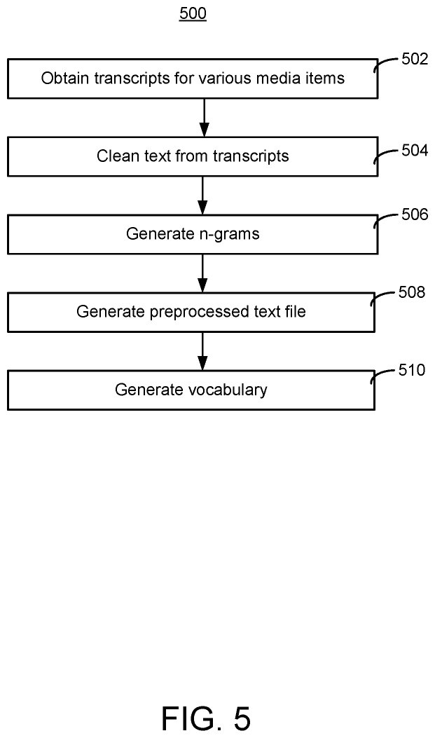

FIG. 5 is a flow diagram illustrating a vocabulary generation method 500 in accordance with some embodiments. The method 500 may be performed at a computing system (e.g., media content server 104 and/or electronic device(s) 102) having one or more processors and memory storing instructions for execution by the one or more processors. In some embodiments, the method 500 is performed by executing instructions stored in the memory (e.g., memory 212, FIG. 2 and/or memory 306, FIG. 3) of the computing system. In some embodiments, the method 500 is performed by a combination of the server system (e.g., including media content server 104 and CDN 106) and a client device.

The system obtains (502) transcripts for various media items. In some embodiments, the media items include one or more podcasts, talk shows, and/or audio books. In some embodiments, the media items include one or more segments from a podcast, talk show, and/or audio book. In some embodiments, the transcripts are obtained via a speech-to-text component, such as an automatic speech recognition (ASR) component.

The system cleans (504) the text from the obtained transcripts. In some embodiments, cleaning the text includes identifying words, removing any markup text, and/or performing localization of the transcripts. In some embodiments, cleaning the text includes removing punctuation (e.g., removing commas, apostrophes, quotes, question marks, exclamation points, and/or periods). In some embodiments, cleaning the text includes removing one or more stop words (e.g., words identified as not containing much useful information). In some embodiments, the system obtains a list of lowercase words for each media item by removing punctuation and/or cleaning the text from the obtained transcripts.

The system generates (506) n-grams from the cleaned text. For example, the system generates a set of n-grams from a cleaned transcript (e.g., a list of lowercase words). In some embodiments, each n-gram includes one or more words. For example, the n-grams include one or more unigrams, bigrams, and/or trigrams. In some embodiments, the system filters the cleaned text (e.g., before, during, or after generating the n-grams). In some embodiments, filtering the cleaned text includes filtering by minimum co-occurrence within the media item (e.g., episode). For example, terms that don't have a co-occurrence of at least ‘n’ may be filtered out, where ‘n’ is at least 1.

In some embodiments, in addition to, or alternatively to, generating the n-grams, the system pre-processes the cleaned text. In some embodiments, pre-processing the cleaned text includes generating one or more lists of representative vocabulary (e.g., lists of infrequent and/or undefined terms). In some embodiments, pre-processing the cleaned text includes generating a list of representative phrases and/or sentences (e.g., common phrases). In some embodiments, a list of representative vocabulary includes phrases and/or sentences to convey particular topics. For example, a list of representative vocabulary may include a longer phrase such as “Shoeless Joe Jackson banned from game after World Series fix” rather than individual words or shorter phrases (e.g., “Shoeless Joe Jackson” or “Black Sox”). In some embodiments, pre-processing the cleaned text includes generating a list of representative entity names (e.g., a list of host names). For example, a list of representative vocabulary may include media titles and/or host names.

The system generates (508) a preprocessed text based on the obtained transcripts and generated n-grams. In some embodiments, the system combines the generated n-grams with a list of lowercase words from the transcript (e.g., a list of lowercase words obtained after removal of stop words) to generate a set of terms. In some embodiments, the system filters the set of terms prior to generating the preprocessed text. For example, the system applies a term frequency and inverse document frequency (TF-IDF) filter. In some embodiments, the filtering includes comparing a minimum document count and a maximum percentage of document occurrence.

The system generates (510) a vocabulary (e.g., words and expressions from the transcripts) from the preprocessed text. For example, the system generates a vocabulary file (e.g., a pkl file) from the preprocessed text. In some embodiments, the system generates one or more sparse token and/or count matrices from the vocabulary (e.g., for training and/or evaluation).

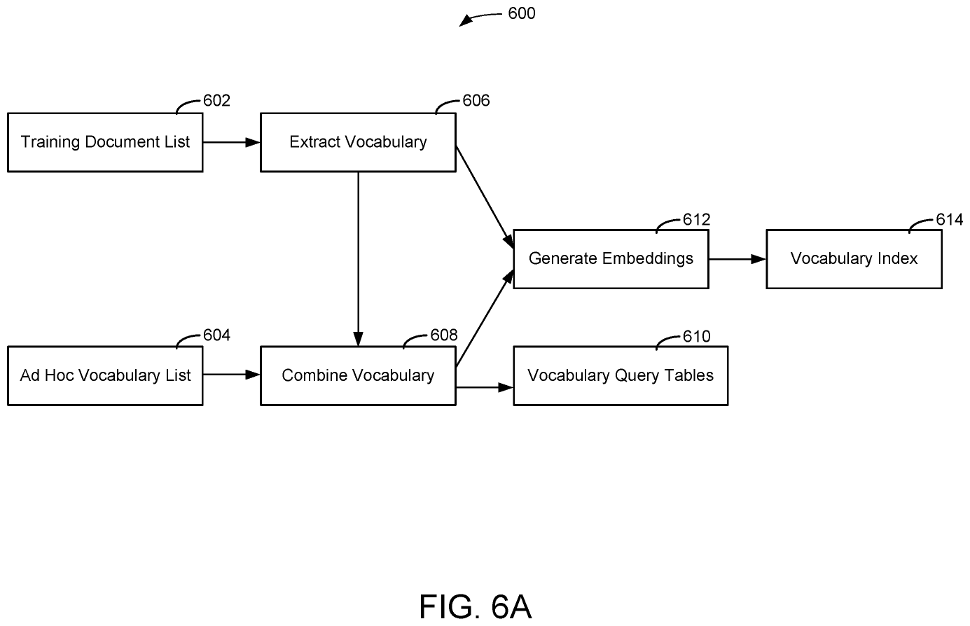

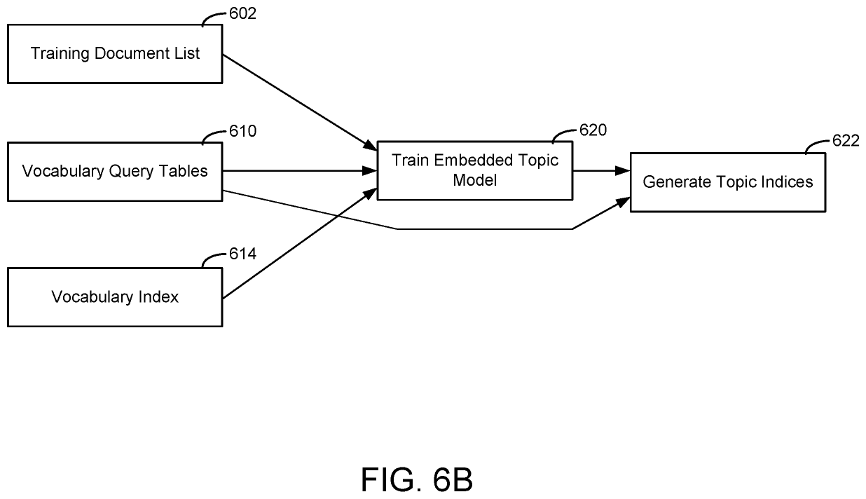

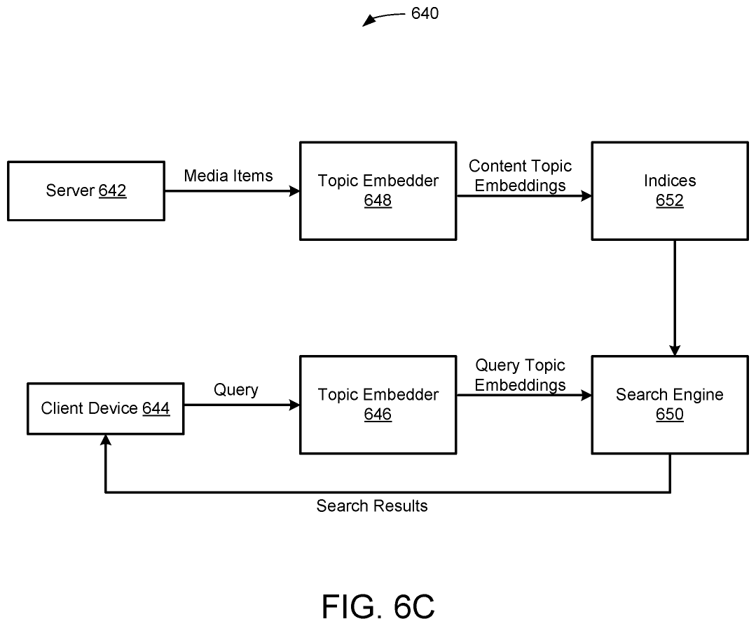

FIGS. 6A-6B are a flow diagram illustrating an example indexing method 600 in accordance with some embodiments. The method 600 may be performed at a computing system (e.g., media content server 104 and/or electronic device(s) 102) having one or more processors and memory storing instructions for execution by the one or more processors. In some embodiments, the method 600 is performed by executing instructions stored in the memory (e.g., memory 212, FIG. 2 and/or memory 306, FIG. 3) of the computing system. In some embodiments, the method 600 is performed by a combination of the server system (e.g., including media content server 104 and CDN 106) and a client device.

The system obtains (602) a training document list. In some embodiments, the training document list includes one or more transcripts for a media item. In some embodiments, the training document list includes a list of lowercase words generated from one or more transcripts for a media item. In some embodiments, the training document list includes audio transcripts for multiple podcasts, videos, talk shows, audio books, and/or segments thereof (e.g., chapters and/or clips).

The system extracts (606) vocabulary from the training document list. In some embodiments, extracting the vocabulary includes performing the method 500 (FIG. 5). In some embodiments, the vocabulary includes one or more terms and one or more phrases. In some embodiments, extracting vocabulary includes cleaning text and/or generating n-grams.

The system obtains (604) an ad hoc vocabulary list (e.g., including one or more named entities). In some embodiments, the ad hoc vocabulary list is generated/revised manually to ensure that particular terms or named entities are included. For example, the ad hoc vocabulary list may include terms/entities that have low frequency (e.g., may be ignored/minimized by frequency-based models) but high distinctiveness (e.g., are important for distinguishing media items from one another).

The system combines (608) the extracted vocabulary with the ad hoc vocabulary list. In some embodiments, the system combines two or more extracted vocabularies with one or more ad hoc vocabulary lists. In some embodiments, the combined vocabulary includes one or more words, n-grams, sentences, and/or named entities. In some embodiments, the combined vocabulary includes one or more phrases and/or one or more expressions. For example, each vocabulary term may be an arbitrary string up to a preset length (e.g., 512-bit token). The system generates (610) vocabulary query tables based on the combined vocabulary.

The system generates (612) embeddings based on the extracted vocabulary and/or the combined vocabulary. In some embodiments, the embeddings are variable embeddings. In some embodiments, the embeddings are based on byte-pair encodings (BPEs). In some embodiments, the embeddings are generated using a transformer model, such as BERT, BART, XLM, or SentenceBERT. In some embodiments, the embeddings are generated using the words, phrases, and/or expressions in the combined vocabulary (e.g., using SentenceBERT). In some embodiments, the embeddings represent the combined vocabulary in semantic space. In some embodiments, the system generates embeddings that are continuous and semantically coherent (e.g., so that a user can compare any two strings in the embedding space).

The system generates (614) a vocabulary index from the generated embeddings. In some embodiments, the vocabulary index includes one or more terms and one or more phrases. In some embodiments, the vocabulary index includes a respective embedding for each term and phrase in the combined vocabulary.

The system trains (620) an embedded topic model based on the training document list, the vocabulary query tables, and the vocabulary index. In some embodiments, the embedded topic model is, or includes, a deep neural network (DNN) that learns topic embeddings and proportions from the training document list. In some embodiments, the embedded topic model includes, or uses, a pre-trained transformer model, such as BERT, BART, XLM, or SentenceBERT, to learn vocabulary embeddings. In some embodiments, the model is trained on a set number of topics (e.g., 100-2000 topics). In some embodiments, the embedded topic model is trained to return proportions over topics for input items (e.g., media items and/or queries). In some embodiments, the model is trained using the vocabulary index and co-occurrence information (e.g., where the vocabulary terms occur in the training documents). In some embodiments, editing the vocabulary index (e.g., adding and/or removing terms/embeddings from the index) does not require retraining the ETM.

Queries from users and the indexed media content can contain different frequent vocabulary and term associations. In some embodiments, a media content vocabulary is extracted, as described previously, and a query content vocabulary is extracted separately. In some embodiments, the query content vocabulary is extracted as described previously and/or using one or more ad hoc vocabulary lists. In some embodiments, the media content vocabulary and the query content vocabulary are aggregated and then used to train the model.

The system generates (622) topic indices based on the embedded topic model and the vocabulary query tables. In some embodiments, the topic indices include a topic index for episodes and a topic index for segments. In some embodiments the topic indices include a topic index for chapters and/or a topic index for clips.

FIG. 6C is a flow diagram illustrating a searching method 640 in accordance with some embodiments. The method 640 may be performed at a computing system (e.g., media content server 104 and/or electronic device(s) 102) having one or more processors and memory storing instructions for execution by the one or more processors. In some embodiments, the method 640 is performed by executing instructions stored in the memory (e.g., memory 212, FIG. 2 and/or memory 306, FIG. 3) of the computing system. In some embodiments, the method 640 is performed by a combination of the server system (e.g., including media content server 104 and CDN 106) and a client device.

The system obtains one or more media items from a server 642. For example, the system may obtain episodes for a podcast or talk show. In some embodiments, the media items include one or more podcasts, talk shows, audio books, and/or segments thereof.

The system generates one or more content topic embeddings for the media item(s) using a topic embedder 648. In some embodiments, the topic embedder 648 is configured to perform topic modeling (e.g., deriving representative sets of terms for media items). In some embodiments, the topic embedder 648 generates an embedding for each media item (e.g., a one-to-one relationship).

The system generates one or more topic indices 652 based on the generated topic embedding(s). In some embodiments, the topic indices 652 include the topic indices generated as described previously with respect to FIG. 6B.

The system obtains a query (e.g., a user query) from a client device 644. In some embodiments, a query is expanded to produce a (comprehensive) semantic search set. The system generates one or more query topic embeddings for the query using a topic embedder 646. In some embodiments, the query topic embeddings are weighted averages of topics for the expanded query set.

The system compares the query topic embeddings to the topic indices 652 using a search engine 650. In some embodiments, the query text is input into a machine learning model (e.g., an ETM) that returns topic proportions as outputs. In some embodiments, the topic proportions are used to identify topic embeddings from the topic indices and generate a query embedding. In some embodiments, the query embedding is used to calculate nearest neighbor media (e.g., episodes, segments, and the like). In some embodiments, term-based sentiment analysis is performed using the query topic embeddings. In some embodiments, the system performs sentiment analysis to compare the query to the topic indices. The system (e.g., the search engine 650) returns one or more search results based on the comparison. In some embodiments, the search results are based on the term-based sentiment analysis. In some embodiments, the topic embedder 646 and/or 648 includes a sentiment layer. In some embodiments, the sentiment layer is a transformer-based transcript search that identifies relevant regions and/or topics. In some embodiments, the system selects relevant regions for the query as the search results. In some embodiments, the system uses the relevant regions to query a topic space for nearest neighbors and includes one or more nearest neighbors as a portion of the search results.

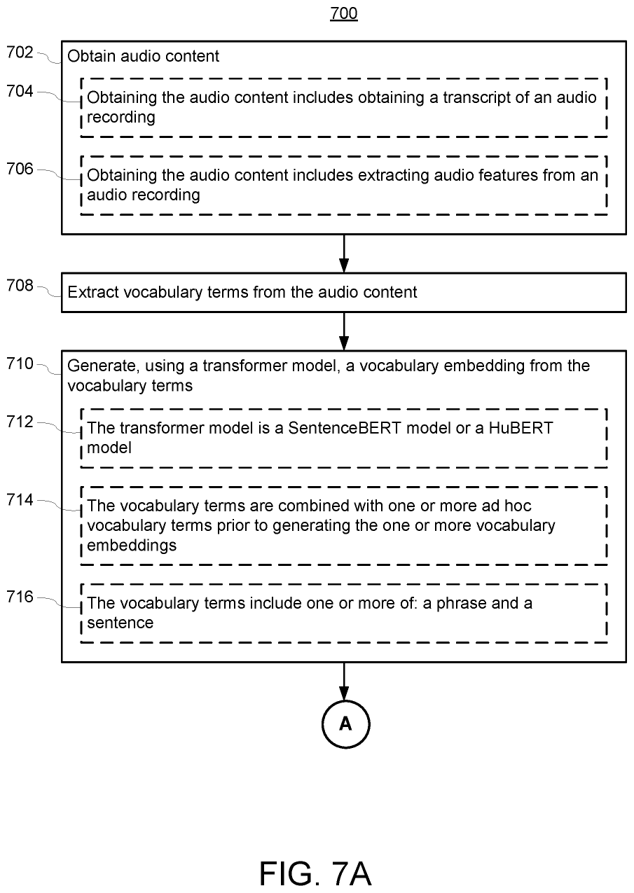

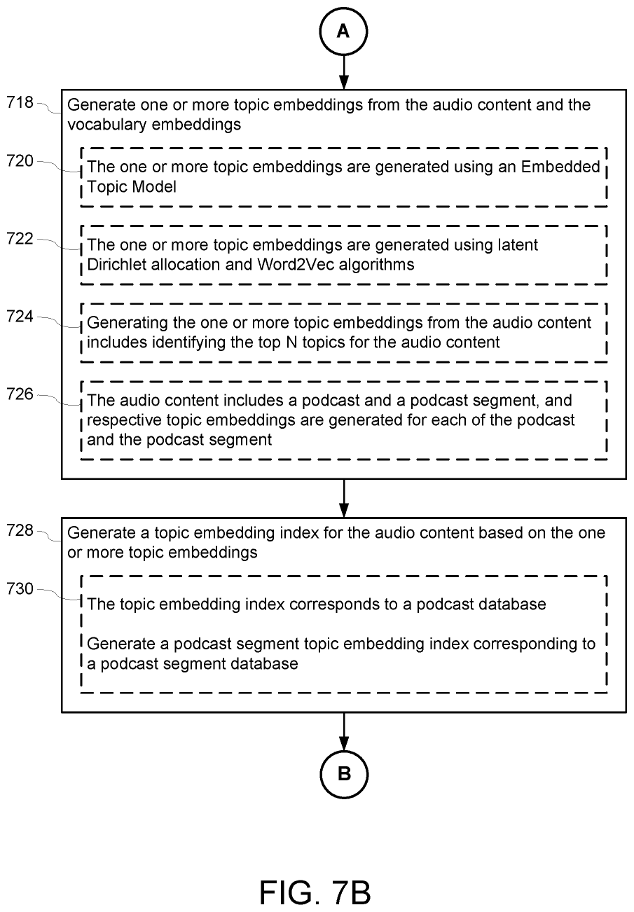

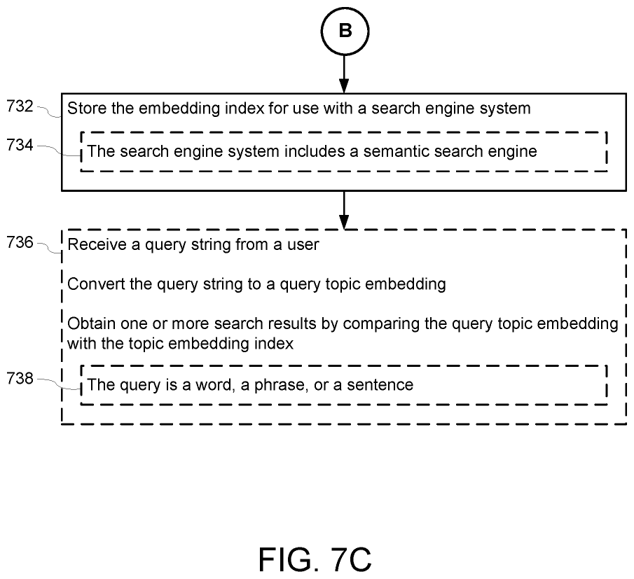

FIGS. 7A-7C are flow diagrams illustrating a method 700 of generating a topic index in accordance with some embodiments. The method 700 may be performed at a computing system (e.g., media content server 104 and/or electronic device(s) 102) having one or more processors and memory storing instructions for execution by the one or more processors. In some embodiments, the method 700 is performed by executing instructions stored in the memory (e.g., memory 212, FIG. 2 and/or memory 306, FIG. 3) of the computing system. In some embodiments, the method 700 is performed by a combination of the server system (e.g., including media content server 104 and CDN 106) and a client device.

The system obtains (702) audio content (e.g., corresponding to one or more media items). In some embodiments, the audio content includes text representation of the audio content (e.g., a transcript). In some embodiments, the audio content includes one or more documents generated from the audio content (e.g., the documents 402).

In some embodiments, obtaining the audio content includes (704) obtaining a transcript of an audio recording. In some embodiments, the transcript is a cleaned transcript (e.g., that does not include punctuation, stop words, and/or capitalization).

In some embodiments, obtaining the audio content includes (706) extracting audio features from an audio recording. In some embodiments, the audio features include one or more of: energy function, fundamental frequency, loudness, pitch, timbre, and/or rhythm. In some embodiments, the audio features include mood and/or genre. In some embodiments, the audio features include amplitude envelope, root mean square (RMS) energy, and/or spectral bandwidth.

The system extracts (708) vocabulary terms from the audio content. The system generates (710), using a transformer model, a vocabulary embedding from the vocabulary terms. In some embodiments, the system generates multiple n-grams from the audio content for the vocabulary embedding (e.g., as described previously with respect to FIG. 5).

In some embodiments, the transformer model is (712) a SentenceBERT model or a HuBERT model. In some circumstances, using a transformer model allows for expanding the vocabulary without requiring retraining of the model. In some embodiments, the audio content includes one or more audio recordings, and the model is an audio-based transformer model, such as a HuBERT model. In some embodiments, the audio content includes one or more text transcripts, and the model is a text-based transformer model, such as SentenceBERT.

In some embodiments, the vocabulary terms are combined with (714) one or more ad hoc vocabulary terms prior to generating the one or more vocabulary embeddings. In some embodiments, the ad hoc vocabulary terms are obtained from an ad hoc vocabulary list (e.g., as described previously with respect to FIG. 6A).

In some embodiments, the vocabulary terms include (716) one or more of a phrase and a sentence. In some embodiments, the vocabulary terms include one or more phrases, expressions, named entities, and/or sentences.

The system generates (718) one or more topic embeddings from the audio content and the vocabulary embeddings. In some embodiments, a single embedding vector is generated for each respective media item. In some embodiments, the one or more topic embeddings include a respective topic vector for each media item.

In some embodiments, the one or more topic embeddings are generated using (720) an Embedded Topic Model (ETM). In some embodiments, the ETM is trained using a set of training documents and a vocabulary index (as described previously with respect to FIG. 6B). In some embodiments, the one or more topic embeddings are generated using (722) latent Dirichlet allocation and/or Word2vec algorithms.

In some embodiments, generating the one or more topic embeddings from the audio content includes (724) identifying the top N topics for the audio content. For example, for a given podcast, a set of 10 topics can be selected from the podcast episode, where the 10 topics selected represent the topics most discussed in the episode. In some embodiments, the number of topics identified is based on a number of topics discussed in the episode. In some embodiments, the number of topics identified is based on respective scores for each identified topic (e.g., only topics having a respective score of at least a preset threshold are included).

In some embodiments, the audio content includes (726) a podcast and a podcast segment, and respective topic embeddings are generated for each of the podcast and the podcast segment. In some embodiments, a single topic embedding is generated for each respective media item. In some embodiments, a single topic embedding is generated for each respective media item segment.

The system generates (728) a topic embedding index for the audio content based on the one or more topic embeddings. In some embodiments: (i) the topic embedding index corresponds to (730) a podcast database; and (ii) the system generates a podcast segment topic embedding index corresponding to a podcast segment database. In some embodiments, the topic embedding index represents a mapping of content-to-content embeddings corresponding to a podcast database, where content includes episodes, segments (e.g., chapters and/or clips), and topics themselves.

The system stores (732) the embedding index for use with a search engine system (e.g., the search module 324). In some embodiments, the system stores an embedding index for each type of media item. For example, the system stores a first embedding index for podcast episodes and a second embedding index for podcast segments. In some embodiments, the system stores the embedding index in a media content database (e.g., the media content database 332).

In some embodiments, the search engine system includes (734) a semantic search engine (e.g., the search module 324). For example, the search engine system is configured to perform a semantic search in response to queries (e.g., as described previously with respect to FIG. 6C).

In some embodiments, the system: (i) receives (736) a query string from a user; (ii) converts the query string to a query topic embedding; and (iii) obtains one or more search results by comparing the query topic embedding with one or more topic embedding indices. In some embodiments, the search results include one or more media types. In some embodiments, the system identifies k nearest neighbors in the topic embedding index for a query and returns at least a portion of the k nearest neighbors as search results. In some embodiments, the query is (738) a word, a phrase, or a sentence.

Although FIGS. 5, 6A-6C, and 7A-7C illustrate a number of logical stages in a particular order, stages which are not order dependent may be reordered and other stages may be combined or broken out. Some reordering or other groupings not specifically mentioned will be apparent to those of ordinary skill in the art, so the ordering and groupings presented herein are not exhaustive. Moreover, it should be recognized that the stages could be implemented in hardware, firmware, software, or any combination thereof.

Turning now to some example embodiments.

(A1) In one aspect, some embodiments include a method (e.g., the method 700) of generating a topic index. The method is performed at a computing device (e.g., the electronic device 102 or the media content server 104) having one or more processors and memory. The method includes: (i) obtaining audio content (e.g., from the media content database 332); (ii) extracting vocabulary terms from the audio content (e.g., obtaining cleaned text from the audio content); (iii) generating, using a transformer model, a vocabulary embedding from the vocabulary terms (e.g., generating n-grams from the vocabulary terms); (iv) generating one or more topic embeddings from the audio content and the vocabulary embeddings; (v) generating a topic embedding index (e.g., using the indexing module 322) for the audio content based on the one or more topic embeddings; and (vi) storing the embedding index (e.g., in the media content database 332) for use with a search engine system.

As an example, a Word2vec model needs to be trained on a particular vocabulary, so adding an element to the vocabulary (for example, the union of the existing vocabulary words ‘hot’ and ‘dog’ into a new term ‘hot dog’) requires a user to retrain the Word2vec model (e.g., yielding new and backwards-incompatible embeddings of the vocabulary). Conversely, other transformer models, such as SentenceBERT, are pre-trained and embed arbitrary strings up to a maximum sequence length.

Some embodiments include adding embeddings to topic models composed of vocabularies of words. Some embodiments include adding generalization from word embeddings to sentence/paragraph level embeddings without having to retrain the vocabulary embeddings if new vocabulary is added. Some embodiments include generating embedded topic models based on an extensible vocabulary of words, sentences, and paragraphs.

(A2) In some embodiments of A1, the transformer model is a text-based transformer model (e.g., a SentenceBERT model). In some embodiments, the transformer model is an audio-based transformer model (e.g., a HuBERT model).

(A3) In some embodiments of A1 or A2, the one or more topic embeddings are generated using an Embedded Topic Model (e.g., the ETM discussed previously with respect to FIG. 6B). For example, an ETM that has been trained on a number of topics ranging from 500 to 30000. In some embodiments, the topic embeddings are generated using a topic model. In some embodiments, the topic embeddings are generated using an embedding model.

(A4) In some embodiments of any of A1-A3, the one or more topic embeddings are generated using latent Dirichlet allocation (LDA) and Word2 vec algorithms. In some embodiments, the topic embeddings are generated using an LDA or Word2vec algorithm.

(A5) In some embodiments of any of A1-A4, the audio content includes a podcast (e.g., a podcast episode) and a podcast segment, and respective topic embeddings are generated for each of the podcast and the podcast segment. In some embodiments, the podcast segments are separated into chapters and clips and respective topic embeddings are generated for each chapter and clip.

(A6) In some embodiments of any of A1-A5, generating the one or more topic embeddings from the audio content includes identifying the top N topics for the audio content (e.g., N is 5, 10, 20, or 100). In some embodiments, a relatively small number of top topics are identified (e.g., in the range of 1-20), whereas in other embodiments, a relatively large number of top topics are identified (e.g., in the range of 100-2000). In some embodiments, the topics are ranked/ordered based on proportions over topics and/or a weighted average of topics.

(A7) In some embodiments of any of A1-A6, obtaining the audio content includes obtaining a transcript of an audio recording. For example, obtaining the audio content includes obtaining a transcript for a podcast episode.

(A8) In some embodiments of any of A1-A7, obtaining the audio content includes extracting audio features from an audio recording. For example, extracting audio features includes identifying a spectral bandwidth, amplitude envelope, a mood, and/or a genre.

(A9) In some embodiments of any of A1-A8: (i) the topic embedding index is a podcast topic embedding index corresponding to a podcast database; and (ii) the method further includes generating a podcast segment topic embedding index corresponding to a podcast segment database. For example, the content indices 334 may include a topic embedding index for podcasts and a topic embedding index for podcast segments.

(A10) In some embodiments of any of A1-A9, the topic embedding index corresponds to a podcast database (e.g., the media content database 332) that includes entries for full episodes and entries for episode segments.

(A11) In some embodiments of any of A1-A10, the search engine system includes a semantic search engine (e.g., the search module 324). As an example, the search engine system includes the search engine 650.

(A12) In some embodiments of any of A1-A11, the vocabulary terms are combined with one or more ad hoc vocabulary terms prior to generating the one or more vocabulary embeddings. As an example, ad hoc vocabulary terms may include one or more named entities. Ad hoc vocabulary terms may also include common expressions, such as “welcome to my podcast” or named entities such as “Joe Rogan.”

(A13) In some embodiments of any of A1-A12, the vocabulary terms include one or more of: a phrase and a sentence. In some embodiments, the vocabulary terms include the combined vocabulary described previously with respect to FIG. 6A.

(A14) In some embodiments of any of A1-A13, the method further includes: (i) receiving a query string from a user; (ii) converting the query string to a query topic embedding; and (iii) obtaining one or more search results by comparing the query topic embedding with the topic embedding index (e.g., using cosine similarity and/or KNN results). In some embodiments, the query string is converted to a query topic embedding in the same vector space as topic embeddings from media items. In some embodiments, an ordered sequence (e.g., a playlist) is generated or identified based on the one or more search results.

(A15) In some embodiments of A14, the query is a word, a phrase, or a sentence (e.g., a natural language input). For example, the query is received from the client device 644 as described previously with respect to FIG. 6C. As another example, the query is received via the search module 227 of the electronic device 102.

(A16) In some embodiments of any of A1-A15, extracting the vocabulary terms from the audio content includes one or more of: removing punctuation and stop words from a transcript, and filtering one or more words from the transcript (e.g., using TF-IDF).

In another aspect, some embodiments include a computing system including one or more processors and memory coupled to the one or more processors, the memory storing one or more programs configured to be executed by the one or more processors, the one or more programs including instructions for performing any of the methods described herein (e.g., the methods 500, 540, 600, and 700 as well as A1-16 above).

In yet another aspect, some embodiments include a non-transitory computer-readable storage medium storing one or more programs for execution by one or more processors of a computing system, the one or more programs including instructions for performing any of the methods described herein (e.g., the methods 500, 540, 600, and 700 as well as A1-16 above).

It will also be understood that, although the terms first, second, etc. are, in some instances, used herein to describe various elements, these elements should not be limited by these terms. These terms are used only to distinguish one element from another. For example, a first electronic device could be termed a second electronic device, and, similarly, a second electronic device could be termed a first electronic device, without departing from the scope of the various described embodiments. The first electronic device and the second electronic device are both electronic devices, but they are not the same electronic device.

The terminology used in the description of the various embodiments described herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting” or “in accordance with a determination that,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event]” or “in accordance with a determination that [a stated condition or event] is detected,” depending on the context.

The foregoing description, for purpose of explanation, has been described with reference to specific embodiments. However, the illustrative discussions above are not intended to be exhaustive or to limit the embodiments to the precise forms disclosed. Many modifications and variations are possible in view of the above teachings. The embodiments were chosen and described in order to best explain the principles and their practical applications, to thereby enable others skilled in the art to best utilize the embodiments and various embodiments with various modifications as are suited to the particular use contemplated.

What is claimed is:

1. A method of generating a topic index, the method comprising:
obtaining audio content;
extracting vocabulary terms from the audio content;
generating, using a transformer model, a vocabulary embedding from the vocabulary terms;
generating one or more topic embeddings from the audio content and the vocabulary embeddings;
generating a topic embedding index for the audio content based on the one or more topic embeddings; and
storing the embedding index for use with a search engine system.

2. The method of claim 1, wherein the transformer model comprises a SentenceBERT model.

3. The method of claim 1, wherein the one or more topic embeddings are generated using an Embedded Topic Model (ETM).

4. The method of claim 1, wherein the one or more topic embeddings are generated using latent Dirichlet allocation (LDA) and Word2vec algorithms.

5. The method of claim 1, wherein the audio content comprises a podcast and a podcast segment, and respective topic embeddings are generated for each of the podcast and the podcast segment.

6. The method of claim 1, wherein generating the one or more topic embeddings from the audio content comprises identifying the top N topics for the audio content.

7. The method of claim 1, wherein obtaining the audio content comprises obtaining a transcript of an audio recording.

8. The method of claim 1, wherein obtaining the audio content comprises extracting audio features from an audio recording.

9. The method of claim 1, wherein the topic embedding index is a podcast topic embedding index corresponding to a podcast database; and
the method further comprises generating a podcast segment topic embedding index corresponding to a podcast segment database.

10. The method of claim 1, wherein the topic embedding index corresponds to a podcast database that includes entries for full episodes and entries for episode segments.

11. The method of claim 1, wherein the search engine system comprises a semantic search engine.

12. The method of claim 1, wherein the vocabulary terms are combined with one or more ad hoc vocabulary terms prior to generating the one or more vocabulary embeddings.

13. The method of claim 1, wherein the vocabulary terms include one or more of: a phrase and a sentence.

14. The method of claim 1, further comprising:
receiving a query string from a user;
converting the query string to a query topic embedding; and
obtaining one or more search results by comparing the query topic embedding with the topic embedding index.

15. The method of claim 14, wherein the query is a word, a phrase, or a sentence.

16. The method of claim 1, wherein extracting the vocabulary terms from the audio content includes one or more of: removing punctuation and stop words from a transcript, and filtering one or more words from the transcript.

17. A computing device, comprising:
one or more processors;
memory; and
one or more programs stored in the memory and configured for execution by the one or more processors, the one or more programs comprising instructions for:
obtaining audio content;
extracting vocabulary terms from the audio content;
generating, using a transformer model, a vocabulary embedding from the vocabulary terms;
generating one or more topic embeddings from the audio content and the vocabulary embeddings;
generating a topic embedding index for the audio content based on the one or more topic embeddings; and
storing the embedding index for use with a search engine system.

18. The device of claim 17, wherein the one or more programs further comprise instructions for:
receiving a query string from a user;
converting the query string to a query topic embedding; and
obtaining one or more search results by comparing the query topic embedding with the topic embedding index.

19. A non-transitory computer-readable storage medium storing one or more programs configured for execution by a computing device having one or more processors and memory, the one or more programs comprising instructions for:
obtaining audio content;
extracting vocabulary terms from the audio content;
generating, using a transformer model, a vocabulary embedding from the vocabulary terms;
generating one or more topic embeddings from the audio content and the vocabulary embeddings;
generating a topic embedding index for the audio content based on the one or more topic embeddings; and
storing the embedding index for use with a search engine system.

20. The non-transitory computer-readable storage medium of claim 19, wherein the one or more programs further comprise instructions for:
receiving a query string from a user;
converting the query string to a query topic embedding; and
obtaining one or more search results by comparing the query topic embedding with the topic embedding index.
